(19) United States
(12) Patent Application Publication
(10) Pub. No.: US 2025/0383964 A1
(43) Pub. Date: Dec. 18, 2025

(54) ENHANCED DATA PROTECTION SCHEMES FOR MEMORY SYSTEMS

(71) Applicant: Micron Technology, Inc., Boise, ID (US)

(72) Inventors: Andrea Vigilante, Milano (MI) (IT); Sean L. Manion, Boise, ID (US); Paolo Amato, Treviglio (BG) (IT); Peter Feeley, Boise, ID (US); Xiangang Luo, Fremont, CA (US); Giuseppe Rizzari, Ragusa (RG) (IT)

(21) Appl. No.: 19/224,399

(22) Filed: May 30, 2025

Related U.S. Application Data
(60) Provisional application No. 63/660,953, filed on Jun. 17, 2024.

(51) Int. Cl. G06F 11/10

(52) U.S. Cl. CPC G06F 11/108; G06F 11/1048

(57) ABSTRACT

Methods, systems, and devices for enhanced data protection schemes for memory systems are described. An apparatus may generate multiple parity bit sets for a data recovery procedure, where each parity bit set may correspond to a respective subset of a respective logical page of multiple logical pages at a memory system. In such examples, a first subset of the multiple parity bit sets may correspond to respective lower subsets of a first subset of the multiple logical pages and a second subset of the multiple parity bit sets may correspond to respective upper subsets of a second subset of the multiple logical pages. The apparatus may detect a corruption of data at a first logical page of the memory system and recover, as part of the data recovery procedure, the data using a first parity bit set that corresponds to the first logical page.

### CROSS REFERENCE

The present Application for Patent claims priority to U.S. Patent Application No. 63/660,953 by Vigilante et al., entitled “ENHANCED DATA PROTECTION SCHEMES FOR MEMORY SYSTEMS,” filed Jun. 17, 2024, which is assigned to the assignee hereof, and which is expressly incorporated by reference in its entirety herein.

### TECHNICAL FIELD

The following relates to one or more systems for memory, including enhanced data protection schemes for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports enhanced data protection schemes for memory systems in accordance with examples as disclosed herein.

FIG. 2 shows an example of a memory architecture that supports enhanced data protection schemes for memory systems in accordance with examples as disclosed herein.

FIG. 3A shows an example of a data protection scheme that supports enhanced data protection schemes for memory systems in accordance with examples as disclosed herein.

FIG. 3B shows an example of a data protection scheme that supports enhanced data protection schemes for memory systems in accordance with examples as disclosed herein.

FIG. 4A shows an example of a data protection scheme that supports enhanced data protection schemes for memory systems in accordance with examples as disclosed herein.

FIG. 4B shows an example of a data protection scheme that supports enhanced data protection schemes for memory systems in accordance with examples as disclosed herein.

FIG. 5 shows an example of a data protection scheme that supports enhanced data protection schemes for memory systems in accordance with examples as disclosed herein.

FIG. 6 shows a block diagram of a memory system that supports enhanced data protection schemes for memory systems in accordance with examples as disclosed herein.

FIG. 7 shows a flowchart illustrating a method or methods that support enhanced data protection schemes for memory systems in accordance with examples as disclosed herein.

### DETAILED DESCRIPTION

Some memory systems may implement data protection schemes, such as redundant array of independent not-AND (NAND) (RAIN) schemes, to increase the reliability and the performance of data storage by spreading a set of data across respective logical pages of multiple planes of memory cells, such that if a first subset of the data is corrupted at a first logical page of a first plane, the first set of the data may be recovered using one or more other remaining sets of data stored in the first logical pages of the remaining planes. In such examples, the set of data stored across the multiple planes may be referred to as a RAIN stripe and be associated with a respective RAIN stripe identifier (ID). In some cases, as part of the data protection scheme, the memory system may calculate respective parity bits for each set of data (e.g., each RAIN stripe) stored at respective sets of logical pages of the multiple planes, where the combination of the respective parity bits may provide protection of data stored for a single word line (among other examples) and protect data stored in each logical page (e.g., 16 kilobyte (KB) logical page) (among other examples).

The memory system may store parity bits in volatile memory (e.g., static random access memory (SRAM)). However, a size of the parity bits stored in the volatile memory may be relatively large due to protecting data across a single word line and each logical page, leading to a reduction of resources in the volatile memory. In such examples, it may be advantageous to generate and store parity bits that protect data at a half word line, as the size of the such parity bits may be less relative to the size of the parity bits protecting data at a full word line. However, some other different techniques to generate parity bits for protection of data at a half word line may lead to various drawbacks, such as not providing protection for data stored at a full logical page (e.g., 16 KB logical page), leading to the implementation of additional circuitry, or both.

In accordance with the techniques described herein, a system such as a memory system or a host system may generate multiple parity bit sets, where a first subset of the multiple parity bit sets may correspond to data stored at a first subset, such as a lower subset, of each logical page of a first subset of logical pages across the multiple planes and a second subset of the multiple parity bit sets may correspond to data stored at a second subset, such as an upper subset, of each logical page of the first subset of logical pages across the multiple planes. Accordingly, the multiple parity bit sets generated to cover the first subsets (e.g., lower subsets) and the second subsets (e.g., upper subsets) of a first subset of logical pages across the multiple planes may provide protection for data stored at a subset of a word line, such as a half word line, that corresponds to the first subset of logical pages and also protects the data stored at the full logical page of each of the first subset of logical pages. By generating such parity bit sets, the memory system may reduce the quantity of parity bit sets stored in the volatile memory, while also avoiding the inclusion of additional circuitry to maintain protection for the data stored at a half word line, among other advantages.

In addition to applicability in memory systems as described herein, techniques for enhanced data schemes may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by implementing parity bits (e.g., RAIN stripes) that cover single logical page (e.g., 16 KB of data) and a halfword line, which may decrease the quantity of parity bit stored in volatile memory (e.g., SRAM) of a memory system, thereby increasing performance and reducing wasted resources at the memory system, among other benefits.

Features of the disclosure are illustrated and described in the context of systems, devices, and circuits. Features of the disclosure are further illustrated and described in the context of memory architecture, data protection schemes, and flowcharts.

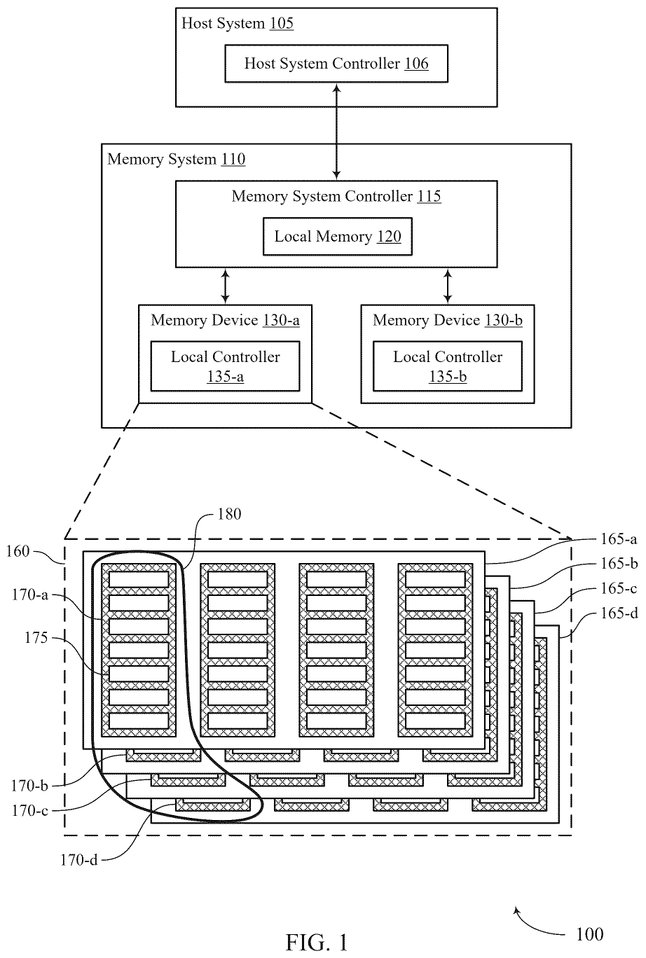

FIG. 1 shows an example of a system 100 that supports enhanced data protection schemes for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical page addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may implement data protection schemes, such as RAIN schemes, to increase the reliability and performance of data storage by spreading a set of data across respective logical pages of multiple planes 165, such that if a first subset of the data is corrupted, for example, at a first logical page of a first plane, the first set of the data may be recovered using one or more of the remaining sets of data stored in the first logical pages of the remaining planes 165. In such examples, the set of data stored across the multiple planes 165 may be referred to as a RAIN stripe and be associated with a respective RAIN stripe identifier (ID). In some cases, as part of the data protection scheme, the memory system 110 may calculate respective parity bits for each set of data (e.g., each RAIN stripe) stored at the respective logical pages of the multiple planes 165, where the combination of the respective parity bits may provide protection of data stored a single word line and protect data stored in each logical page (e.g., 16 KB logical page).

The memory system 110 may store such parity bits in the local memory 120 (e.g., SRAM, volatile memory). However, a size of the parity bits stored in the local memory 120 may be relatively large due to protecting data across a single word line and each logical page, leading to a reduction of resources in local memory 120. In such examples, it may be advantageous to generate and store parity bits that protect data at a subset of the word line, such as a half word line, as the size of the such parity bits may be less relative to the size of the parity bits protecting data at a full word line. However, some other different techniques to generate parity bits for protection of data at a half word line may lead to various drawbacks, such as not providing protection for data stored at a full logical page (e.g., 16 KB logical page), leading to additional circuitry, or both.

In accordance with the techniques described herein, the memory system 110 (or host system 105) may generate multiple parity bit sets, where a first subset of the multiple parity bit sets may correspond to data stored at a lower subset of each logical page of a first subset of logical pages across the multiple planes 165 and a second subset of the multiple parity bit sets may correspond to data stored at an upper subset of each logical page of the first subset of logical pages across the multiple planes 165. Accordingly, the multiple parity bit sets generated to cover the lower subsets and upper subsets of a first subset of logical pages across the multiple planes 165 may provide protection for data stored at a half word line that corresponds to the first subset of logical pages and also protects the data stored at the full logical page of each of the first subset of logical pages. By generating such parity bit sets, the memory system 110 may reduce the quantity of parity bit sets stored in the local memory 120, while also avoiding the inclusion of additional circuitry to maintain protection for the data stored at a half word line, among other advantages.

The system 100 may include any quantity of non-transitory computer readable media that support enhanced data protection schemes for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

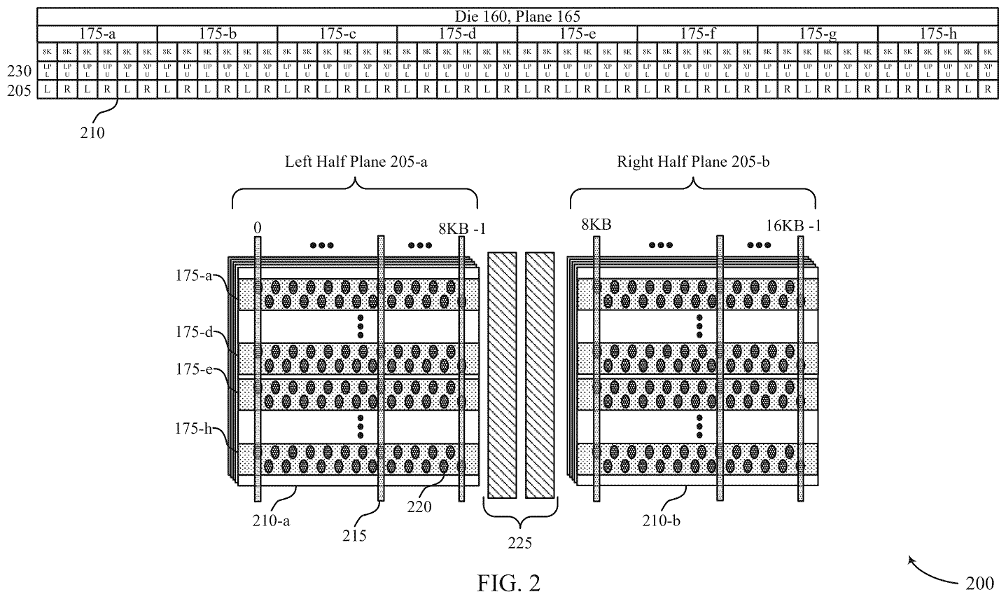

FIG. 2 shows an example of a memory architecture 200 that supports enhanced data protection schemes for memory systems in accordance with examples as disclosed herein. Aspects of the memory architecture may implement, or be implemented by, aspects of the system 100. For example, the memory architecture 200 may illustrate a plane 165 of a die 160 that implements a half-word line architecture, where the die 160 and the plane 165 may be examples of dies 160 and planes 165, as described herein with reference to FIG. 1.

For example, the plane 165 may include one or more subblocks of memory cells, where each subblock may in some examples contain a single page 175. For example, the plane 165 may include a page 175-a, a page 175-b, a page 175-c, a page 175-d, a page 175-c, a page 175-f, a page 175-g, and a page 175-h. The plane 165 may be separated (e.g., divided or split) into a left half plane 205-a and a right half plane 205-b, where each page 175 may span, or be associated with the left half plane 205-a and the right half plane 205-b. The left half plane 205-a may store (e.g., span), 8 KB of data (e.g., 0-8 KB−1), while the right half plane 205-b may store (e.g., span), an additional 8 KB of data (e.g., 8 KB-16 KB−1). As such, each page 175 may store up to 16 KB of data.

Each page 175 may include one or more pillars 220, where each pillar 220 of the one or more pillars 220 may include one or more memory cells at respective levels (in the z direction). Accordingly, the memory system 110 may include a word line 210 at each level of the pillars 220, where each word line 210 may be coupled with respective memory cells of each pillar of each page 175 (e.g., coupled with each subblock). As described, and illustrated, due to the plane 165 being separated into the left half plane 205-a and the right half plane 205-b, the word line 210 may also be separated into a left half word line 210-a and a right half word line 210-b, where the left half word line 210-a may be coupled with the memory cells at the pillars 220 on the left half plane 205-a, while the right half word lines 210-b may be coupled with the memory cells at the pillars 220 on the right half plane 205-b. The memory system 110 may utilize one or more bit lines 215, in conjunction with the word line 210 and string drivers 225, to access one or more memory cells of one or more pillars 220.

Each physical page 175 (e.g., each subblock) may include (e.g., contain or be separated into) multiple logical pages 230, such as a lower logical page (e.g., LP), an upper logical page (e.g., UP), and an extra logical page (e.g., XP). Each of the three logical pages 230 may include (e.g., contain, be composed of, or span) the upper bytes of the right half plane 205-b (e.g., upper bytes or bytes 8 KB-16 KB−1) and lower bytes of the left half plane 205-a (e.g., 0-8 KB−1).

As an illustrative example, the 8 KB of the left half plane 205-a (e.g., L) of the page 175-a may correspond to, or be partitioned into, the lower bytes of a first lower logical page 230 (e.g., LP-L), the lower bytes of a first upper logical page 230 (e.g., UP-L), and the lower bytes of a first extra logical page 230 (e.g., XP-L), while the 8 KB of the right half plane 205-b (e.g., R) of the page 175-a may correspond to, or be partitioned into, the upper bytes of the first lower logical page 230 (e.g., LP-U), the upper bytes of the first upper logical page 230 (e.g., UP-U), and the upper bytes of the first extra logical page 230 (e.g., XP-U). Similarly, the 8 KB of the left half plane 205-a (e.g., L) of the page 175-b may correspond to, or be partitioned into, the lower bytes of a second lower logical page 230 (e.g., LP-L), the lower bytes of a second upper logical page 230 (e.g., UP-L), and the lower bytes of a second extra logical page 230 (e.g., XP-L), while the 8 KB of the right half plane 205-b (e.g., R) of the page 175-a may correspond to, or be partitioned into, the upper bytes of the second lower logical page 230 (e.g., LP-U), the upper bytes of the second upper logical page 230 (e.g., UP-U), and the upper bytes of the second extra logical page 230 (e.g., XP-U). Accordingly, the word line 210 may be associated with each logical page (e.g., LP, UP, and XP) for each page 175 of the plane 165.

In some examples, the logical pages 230 may span multiple planes 165 within a same die 160. For example, the die 160 may include multiple planes 165, such as a first plane 165, a second plane 165, a third plane 165, and a fourth plane 165, where each plane 165 may include a page 175-a, a page 175-b, a page 175-c, and a page 175-d. As such, the pages 175-a across the multiple planes 165 may correspond to lower and upper bytes of a first lower logical page 230, lower and upper bytes of a first upper logical page 230, and lower and upper bytes of a first extra logical page 230. Similarly, the pages 175-b across the multiple planes 165 may correspond to lower and upper bytes of a second lower logical page 230, lower and upper bytes of a second upper logical page 230, and lower and upper bytes of a second extra logical page 230. Thus, in some examples, the die 160, including the four pages 175 per plane 165 may include twelve logical pages 230 (e.g., 3 logical pages per page across each plane multiplied by 4 pages per plane equals 12).

In some cases, the memory system 110 may implement a RAIN scheme (e.g., data protection procedure) to protect data stored at the respective pages 175 of the multiple planes 165 (not shown). As such, during the RAIN scheme, the memory system 110 may receive a first block of data to be written to the upper and lower bytes of the first lower logical pages 230 (LP-L and LP-U) at each page 175-a across the multiple planes 165. Accordingly, the memory system 110 may divide the first block of data into first RAIN stripes (e.g., data segments) with a first RAIN stripe ID (e.g., 0). In such examples, the memory system 110 may assign each first RAIN stripe (e.g., data segment) to different lower and upper bytes of the first lower logical pages 230 within each page 175-a across the multiple planes 165, and may subsequently write each first RAIN stripe (e.g., data segment) to the physical memory cells of the pages 175-a according to (e.g., based on) the assignment.

The memory system 110 may perform such operations for multiple blocks of data, where each block of data may be segmented into respective RAIN stripes with respective RAIN stripe IDs. Accordingly, if respective blocks of data are written to each of the upper and lower bytes of the twelve logical pages 230 across the multiple planes 165, the memory system 110 may include 12 RAIN stripes each with a respective RAIN stripe ID (e.g., 0-11).

As an illustrative example, a block of data written to the lower bytes and upper bytes of the lower logical page 230 across the pages 175-a of each plane 165 may have a RAIN stripe ID of ‘0’, a block of data written to the lower and upper bytes of the upper logical pages 230 across the pages 175-a of each plane 165 may have a RAIN stripe ID of ‘1’, and a block of data written to the lower and upper bytes of the extra logical pages 230 across the pages 175-a of each plane 165 may have a RAIN stripe ID of ‘2’. Similarly, a block of data written to the lower bytes and upper bytes of the lower logical page 230 across the pages 175-b of each plane 165 may have a RAIN stripe ID of ‘3’, a block of data written to the lower and upper bytes of the upper logical pages 230 across the pages 175-b of each plane 165 may have a RAIN stripe ID of ‘4’, and a block of data written to the lower and upper bytes of the extra logical pages 230 across the pages 175-b of each plane 165 may have a RAIN stripe ID of ‘5’.

Additionally, a block of data written to the lower bytes and upper bytes of the lower logical page 230 across the pages 175-c of each plane 165 may have a RAIN stripe ID of ‘6’, a block of data written to the lower and upper bytes of the upper logical pages 230 across the pages 175-c of each plane 165 may have a RAIN stripe ID of ‘7’, and a block of data written to the lower and upper bytes of the extra logical pages 230 across the pages 175-c of each plane 165 may have a RAIN stripe ID of ‘8’. Similarly, a block of data written to the lower bytes and upper bytes of the lower logical page 230 across the pages 175-d of each plane 165 may have a RAIN stripe ID of ‘9’, a block of data written to the lower and upper bytes of the upper logical pages 230 across the pages 175-d of each plane 165 may have a RAIN stripe ID of ‘10’, and a block of data written to the lower and upper bytes of the extra logical pages 230 across the pages 175-d of each plane 165 may have a RAIN stripe ID of ‘11’.

In some cases, as part of the RAIN scheme, the memory system 110 may utilize one or more (e.g., each) of the RAIN stripes to generate parity bits for the respective lower and upper bytes of each logical page 230, thereby protecting data across a full word line 210 and for a full 16 KB logical page 230. That is, to cover a full logical page 230, the memory system 110 may generate a parity bit set for data stored at the lower bytes of a first logical page and generate a parity bit set for data stored at the upper bytes of the first logical page. To cover a full word line 210, the memory system 110 may generate parity bit sets for data stored at lower and upper bytes of each logical page across each page 175 of the plane 165, such that the data stored across the word line 210 may be covered.

For example, to generate parity bits associated with the data stored at the lower bytes of the lower logical page 230 of the pages 175-a (e.g., lower bytes of RAIN stripe ‘0’), the memory system 110 may perform an operation, such as a bitwise XOR operation, on the data stored at the lower bytes of the lower logical pages 230 at the pages 175-a across the planes 165. Similarly, to generate parity bits associated with the data stored at the upper bytes of the lower logical pages 230 of the pages 175-a (e.g., upper bytes of RAIN stripe ‘0’), the memory system 110 may perform an operation, such as a bitwise XOR operation on the data stored at the upper bytes of the lower logical pages 230 at the pages 175-a across the planes 165.

In such cases, the memory system 110 may perform such operations for the lower bytes of each logical page 230 and for the upper bytes of each logical page 230 to generate 24 parity bit sets (e.g., 12 logical pages, each logical page (LP, XP, and UP) includes lower and upper bytes, thus 12 multiplied by two equals 24). By generating such parity bit sets, the memory system 110 may provide protection of data stored a single word line 210 (e.g., protect the data stored on the left half plane 205-a and the right half plane 205-b for the pages 175) and protect data stored in each logical page 230 (e.g., 16 KB logical page). The memory system 110 may store such parity bit sets in the local memory 120 (e.g., SRAM or volatile memory). However, a size of the parity bits stored in the local memory 120 may be relatively large due to protecting data across a single word line 210 and each logical page 230, leading to a reduction of resources in local memory 120.

In such examples, it may be advantageous to generate and store parity bits that protect data at a half word line 210 (e.g., either the left half word line 210-a or the right half word line 210-b), as the size of the such parity bits may be less relative to the size of the parity bits protecting data at a full word line 210. For example, instead of generating a respective parity bit set for the upper and lower bytes of a same logical page 230, the memory system 110 may generate a single parity bit set for each logical page 230 by performing the operation, such as the bitwise XOR operation on both the upper and lower bytes of each logical page 230, thereby reducing the quantity of parity bit sets by a half (e.g., to 12). However, such techniques may lead to various drawbacks, such as not providing protection for data stored at a full logical page 230 (e.g., the granularity between parity bit sets for both upper and lower bytes is lost due to the operation related to the upper and lower bytes, such as XORing the upper and lower bytes together), leading to the implementation of additional circuitry, or both.

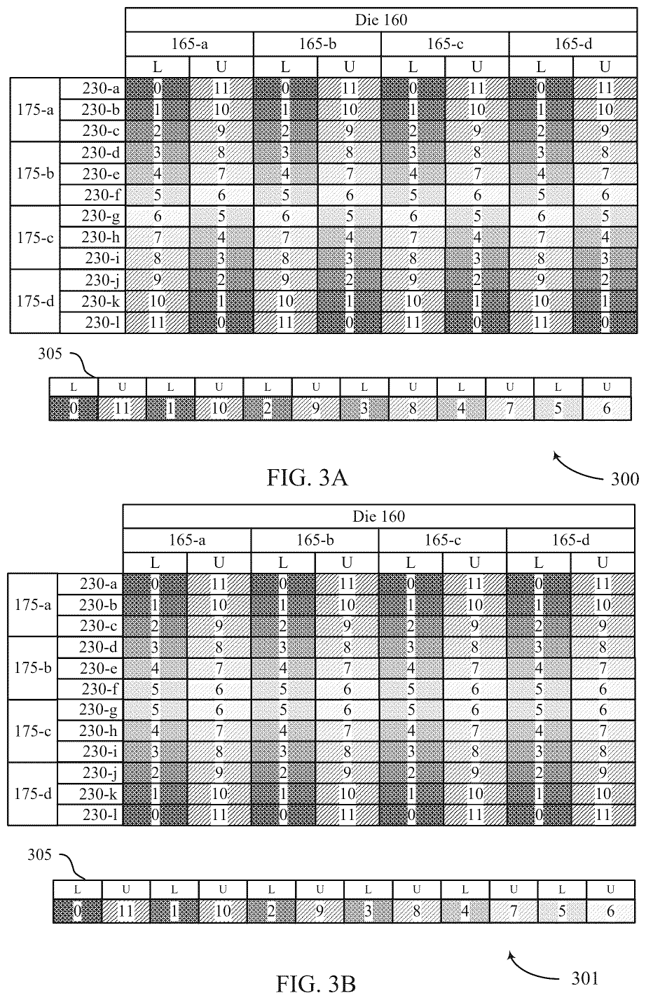

In accordance with the techniques described herein, the memory system 110 may generate multiple parity bit sets, where a first subset of the multiple parity bit sets may correspond to data stored at the lower bytes (e.g., lower subset) of each logical page 230 of a first subset of logical pages across the multiple planes 165 and a second subset of the multiple parity bit sets may correspond to data stored at the upper bytes (e.g., upper subset) of each logical page 230 of the first subset of logical pages 230 across the multiple planes 165. That is, instead of generating a respective parity bit set for each of the logical pages 230 across the planes 165, the memory system 110 may selectively generate parity bit sets for logical pages 230 associated with a subset of the pages 175. In this way, the multiple parity bit sets generated to cover the lower bytes and the upper bytes of the logical pages associated with a subset of the pages 175 may provide protection for data stored at a half word line 210 that corresponds to the subset of the pages 175 and also protects the data stored at the full logical page 230 of each of the first subset of logical pages 230. By generating such parity bit sets, the memory system 110 may reduce the quantity of parity bit sets stored in the local memory 120, while also avoiding the inclusion of additional circuitry to maintain protection for the data stored at a half word line. Techniques to generate such parity bit sets may be further described herein with reference to FIGS. 3A through 5.

Additionally, or alternatively, the host system 105 may generate the parity bit sets to protect data at a half word line and also maintain protection at a full logical page 230. For example, the host system 105 may generate multiple parity bit sets, where a first subset of the multiple parity bit sets may correspond to data stored at the lower bytes (e.g., lower subset) of each logical page 230 of a first subset of logical pages across the multiple planes 165 and a second subset of the multiple parity bit sets may correspond to data stored at the upper bytes (e.g., upper subset) of each logical page 230 of the first subset of logical pages 230 across the multiple planes 165. That is, instead of generating a respective parity bit set for each of the logical pages 230 across the planes 165, the host system 105 may selectively generate parity bit sets for logical pages 230 associated with a subset of the pages 175. In this way, the multiple parity bit sets generated to cover the lower bytes and the upper bytes of the logical pages associated with a subset of the pages 175 may provide protection for data stored at a half word line 210 that corresponds to the subset of the pages 175 and also protects the data stored at the full logical page 230 of each of the first subset of logical pages 230. By generating such parity bit sets, the host system 105 may reduce the quantity of parity bit sets stored in the local memory 120, while also avoiding the inclusion of additional circuitry to maintain protection for the data stored at a half word line.

FIG. 3A shows an example of a data protection scheme 300 that supports enhanced data protection schemes for memory systems in accordance with examples as disclosed herein. Aspects of the data protection scheme 300 may be implemented by aspects of the system 100 and the memory architecture 200. For example, the data protection scheme may be implemented by a memory system 110 (via a memory system controller 115), a host system 105 (via the host system controller 106), or a combination of both. The techniques described in the context of the data protection scheme 300 may enable a memory system 110 to implement a RAIN scheme that protects data stored at a subset of word line 201, half word line 210 and protect data across a full logical page 230 using the multiple parity bit sets 305.

A die 160 may include multiple planes 165, such as a plane 165-a, a plane 165-b, a plane 165-c, and a plane 165-d. Each plane 165 may include respective pages 175. For example, each plane 165 may include respective pages 175-a, 175-b, 175-c, and 175-d. As described herein, each page 175 may be associated with multiple logical pages 230, such as a lower logical page 230 (LP), an upper logical page 230 (UP), and an extra logical page 230 (XP). As such, the die 160 may include 12 logical pages 230, from logical page 230-a (e.g., logical page ‘0’) to logical page 230-1 (e.g., logical page ‘1’). Each logical page 230 may correspond to (e.g., span), respective physical addresses of a same page 175 across the planes 165. For example, the logical page 230-a may correspond to the lower logical page 230 of the pages 175-a across the planes 165-a, 165-b, 165-c, and 165-d, while the logical page 230-1 may correspond to the extra logical page 230 of the pages 175-d across the planes 165-a, 165-b, 165-c, and 165-d.

As described herein, the pages 175 of a respective plane 165 may be associated with a full word line 210. For example, the pages 175-a through 175-d of the plane 165-a may be associated with a first word line 210, while the pages 175-a through 175-d may be associated with a second word line 210. Additionally, each plane 165 may be separated into a left half plane 205-a and a right half plane 205-b, such that each logical page 230 may include lower bytes (e.g., L Bytes) and upper bytes (e.g., U bytes).

In some other different systems, each logical page 230 may be associated with a same RAIN stripe ID. For example, the logical page 230-a may be associated with a RAIN stripe ID of ‘0’, such that the data stored across the lower bytes (e.g., left half plane 205-a) and the upper bytes (e.g., the right half plane 205-b) of each page 175-a across the planes 165 may have a RAIN stripe of ‘0’ (e.g., the first row of the table is all zeros). Similarly, the logical page 230-1 may be associated with a RAIN stripe ID of ‘11’, such that the data stored across the lower bytes and the upper bytes of each page 175-d of across the planes 165 may have a RAIN stripe of ‘11’. As described herein, as part of a RAIN procedure, the memory system 110 may generate a respective parity bit set for the lower bytes of each logical page 230 and a respective parity bit set for the upper bytes of each logical page 230, such that memory system 110 may protect data stored by a single word line 210 associated with the pages 175 and protect data across the lower and upper bytes of each logical page 230. The memory system 110 may store such parity bit sets in the local memory 120 (e.g., SRAM or volatile memory). However, a size of the parity bits stored in the local memory 120 may be relatively large due to protecting data across a single word line 210 and each logical page 230, leading to a reduction of resources in local memory 120.

In such examples, it may be advantageous to generate and store parity bits that protect data at a half word line 210 (e.g., either the left half word line 210-a or the right half word line 210-b), as the size of the such parity bits may be less relative to the size of the parity bits protecting data at a full word line 210. For example, instead of generating a respective parity bit set for the upper and lower bytes of a same logical page 230, the memory system 110 may generate a single parity bit set for each logical page 230 by performing the XOR operation on both the upper and lower bytes of each logical page 230, thereby reducing the quantity of parity bit sets by a half (e.g., to 12). However, such techniques may lead to various drawbacks, such as not providing protection for data stored at a full logical page 230 (e.g., the granularity between parity bit sets for both upper and lower bytes is lost due to XORing the upper and lower bytes together), leading to the implementation of additional circuitry, or both.

In accordance with the techniques described herein, to protect data stored at a half word line 210 and protect both the upper and lower bytes of the logical pages 230, the memory system 110 may change the RAIN stripe ID mapping on the word line 210, such that the lower bytes and the upper bytes of the same logical page 230 may have different RAIN stripe IDs. By doing so, the memory system 110 may protect data stored at the lower bytes (e.g., 8 KB on the left half plane 205-a) and data stored at the upper bytes (e.g., 8 KB on the right half plane 205-b) of the same logical page 230 using different RAIN stripes. That is, the memory system 110 (or host system 105) may change an order of the RAIN stripe ID (e.g., from being sequential to non-sequential), such that the lower bytes and the upper bytes of each RAIN stripe may be associated with different logical pages 230.

As an illustrative example, the memory system 110 may determine that the RAIN stripe ‘0’ is associated with the lower bytes (e.g., the left half plane 205-a) of the logical page 230-a (e.g., corresponding to the left half plane 205-a of the pages 175-a across the planes 165) and is also associated with the upper bytes (e.g., the right half plane 205-b) of the logical page 230-1 (e.g., corresponding to the right half plane 205-b of the pages 175-d across the planes 165).

Accordingly, using the data protection scheme 300, in some examples if S is the quantity of pages 175 (e.g., subblocks) per plane, then the RAIN stripes 0 through (3*(S/2))−1 can protect the left half word line 210-a on the pages 0 through (S/2)−1 and protect the right half word line 210-b on pages S/2 through S−1, while the RAIN stripes (3*(S/2)) through (3*S)−1 can protect the left half word line 210-a on the pages S/2 through S−1 and protect the right half word line 210-b on the pages 0 through (S/2)−1. Thus, as an illustrative example of the aforementioned equations, if S is equal to 4, then RAIN stripes 0-5 protect the lower bytes (e.g., left half plane 205-a or left half word line 210-a) of pages 175-a and 175-b and protect the upper bytes (e.g., right half plane 205-b or right half word line 210-b) of pages 175-c and 175-d. Accordingly, the RAIN stripes 6-11 (e.g., a second subset of the parity bits) protect the upper bytes (e.g., right half plane 205-b or right half word line 210-b) of pages 175-a and 175-b and protect the lower bytes (e.g., left half plane 205-a or left half word line 210-a) of pages 175-c and 175-d.

That is, to protect data stored at a half word line (e.g., data stored at two of the four pages 175) and maintain protection of a full logical page 230, the memory system 110 may generate parity bit sets 305 that include respective parity bit sets associated with the lower bytes of the RAIN stripes 0, 1, 2, 3, 4, and 5 (e.g., first subset) and respective parity bit sets associated with the upper bytes of RAIN stripes 6, 7, 8, 9, 10, and 11 (e.g., second subset). By doing so, the memory system 110 may protect the data stored at the lower bytes and the upper bytes (e.g., all bytes) of logical pages 230-a, 230-b, 230-c, 230-d, 230-c, and 230-f, while also protecting the half word line associated with the pages 175-a and 175-b. Similarly, to protect the upper and lower bytes of the logical pages 230-g, 230-h, 230-i, 230-j, 230-k, and 230-1 and protect the data stored at the half word line associated with the pages 175-c and 175-d, the memory system 110 may generate parity bit sets associated with the lower bytes of RAIN stripes 6-11 (e.g., first subset) and parity bit sets associated with the upper bytes of RAIN stripes 0-5 (e.g., second subset).

As described herein, to generate the parity bit sets 305, the memory system 110 may perform a operation, such as a respective XOR operation, for each RAIN stripe ID. For example, to generate the parity bit set for the lower bytes of the RAIN stripe 0, the memory system 110 may perform a bitwise XOR operation on the data stored at the lower bytes of the logical page 230-a across the planes 165. Similarly, to generate the parity bit set for the upper bytes of RAIN stripe 0, the memory system 110 may perform a bitwise XOR operation on the data stored at the upper bytes of the logical page 230-1 across the planes 165. Based on (e.g., n response to) generating the parity bit sets 305, the memory system 110 may store the parity bit sets 305 in local memory 120, where the memory system 110 may order the parity bit sets 305 sequentially, or non-sequentially, according to the RAIN stripe ID of each parity bit set.

In such examples, due to adjusting the mapping between the RAIN stripe IDs and the logical pages 230, the memory system 110 may write data associated with a same RAIN stripe ID to different logical pages 230. As an illustrative example, the memory system 110 may receive a block of data, segment the block of data into various RAIN stripes, and assign the block of data to a RAIN stripe ID of ‘0’. Accordingly, the memory system 110 may write the segmented block of data into the upper and lower bytes of the logical pages 230 associated with the RAIN stripe ID of ‘0’, such that one or more segments of the data are written to the lower bytes of the logical page 230-a across the planes 165 and to the upper bytes of the logical page 230-b across the planes 165. Alternatively, due to the readdressing the mapping between the RAIN stripe IDs and the logical pages 230, the memory system 110 may write data to the same logical page 230 and assign such data to be associated with different RAIN stripe IDs. As an illustrative example, the memory system 110 may receive a block of data, segment the block of data into RAIN stripes, and assign the RAIN stripes to be written to the logical page 230-a. Accordingly, the RAIN stripes (e.g., data segments) written to the lower bytes of the logical page 230-a may be associated with a RAIN stripe ID of ‘0’, while the RAIN stripes (e.g., data segments) written to the upper bytes of the logical page 230-b may be associated with a RAIN stripe ID of ‘11’.

Accordingly, the memory system 110 may utilize such parity bit sets 305 to recover data during one or more read disturbs (e.g., corruptions). For example, if a corruption is detected in the data stored at the lower bytes of the logical page 230-a, the memory system 110 may utilize the parity bits corresponding to the RAIN stripe ‘0’ to recover the data. Similarly, if a corruption is detected in the data stored at the upper bytes of the logical page 230-b, the memory system 110 may utilize the parity bits corresponding to the RAIN stripe ‘10’ to recover the data.

FIG. 3B shows an example of a data protection scheme 301 that supports enhanced data protection schemes for memory systems in accordance with examples as disclosed herein. Aspects of the data protection scheme 301 may be implemented by aspects of the system 100 and the memory architecture 200. For example, the data protection scheme may be implemented by a memory system 110 (via a memory system controller 115), a host system 105 (via the host system controller 106), or a combination of both. The techniques described in the context of the data protection scheme 301 may enable a memory system 110 to implement a RAIN scheme that protects data stored at a subset of word line 210 (e.g., a half word line 210) and protect data across a full logical page 230 using the multiple parity bit sets 305.

In some examples, based on (e.g., in response to) reordering the RAIN stripe IDs as described herein with reference to FIG. 3A, the memory system 110 (or host system 105, memory system controller 115, such as an ASIC, or memory device 130) may perform address swapping, such that a mapping between the left half word line 210-a and the right half word line 210-b and the and the upper and lower bytes of the planes 165 (e.g., the left half plane 205-a and the right half plane 205-b) may differ between the pages 175. In such examples, the address swapping may be transparent to both the host system 105 and the memory system 110. By performing the address swapping, the memory system 110 may avoid implementing additional circuitry (e.g., such as an 8 KB XOR engine) to support a data protection scheme that protects data stored at a half word line 210 and protects data across a full logical page 230.

In such examples, the memory system 110 may perform various permutations of the address swapping. For example, in the context of the data protection scheme 301, the memory system 110 may perform an address swapping of the RAIN stripe IDs for the pages 175-c and 175-d. For example, as described herein with reference to FIG. 3A, the memory system may reorder the RAIN stripe IDs, such that the RAIN stripes 0-5 may correspond to the lower bytes of the logical pages 230 for pages 175-a and 175-b, thereby protecting data from the left half word line 210-a (e.g., the left half plane 205-a) and that the RAIN stripes 6-11 correspond to the upper bytes of the logical pages for pages 175-a and 175-b, thereby protecting the right half of the word line 210-b (e.g., the right half of the plane 205-b).

According to one permutation of address swapping, the memory system 110 (or host system 105) may determine to swap the addresses between the half word lines 210 and the half planes 205 for the pages 175-c and 175-d, such that the RAIN stripes 0-5 correspond to the lower bytes of the planes 165 (e.g., left half plane 205-a), thereby protecting the right half word line 210-b of the pages 175-c and 175-d, while the RAIN stripes 6-11 correspond to the upper bytes of the planes 165 (e.g., right half plane 205-b), thereby protecting the left half word line 210-a of the pages 175-c and 175-d.

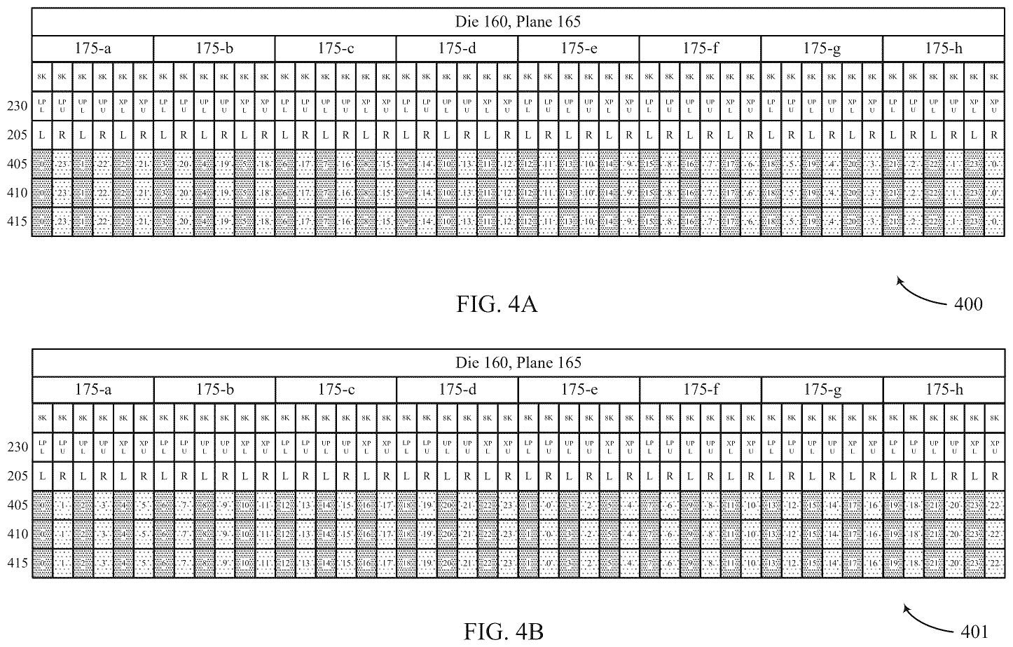

FIG. 4A shows an example of a data protection scheme 400 that supports enhanced data protection schemes for memory systems in accordance with examples as disclosed herein. Aspects of the data protection scheme 400 may be implemented by aspects of the system 100 and the memory architecture 200. For example, the data protection scheme may be implemented by a memory system 110 (via a memory system controller 115), a host system 105 (via the host system controller 106), or a combination of both. The data protection scheme 400 may illustrate reordering of a mapping between the RAIN stripe IDs and logical pages 230 using the techniques described herein with reference to FIG. 3A. That is, the techniques described in the context of the data protection scheme 400 may enable a memory system 110 to implement the techniques of FIG. 3A in the context of additional pages 175 across the planes 165.

In some examples, each plane 165 may include a page 175-a, a page 175-b, a page 175-c, a page 175-d, a page 175-c, a page 175-f, a page 175-g, and a page 175-h. Each page 175 may include three logical pages 230, such as the lower logical page 230, the upper logical page 230, and the extra logical page 230. Each of the logical pages 230 may include respective lower bytes corresponding to a left half plane 205-a (L) and respective upper bytes corresponding to a right half plane 205-a (R). Additionally, as described herein with reference to FIG. 2, the plane 165 may include multiple word lines at each respective level of the pillars 220, such as the word line 405, the word line 410, and the word line 415, where each word line may be separated into a left half word line and a right half word line.

In accordance with the techniques described herein, to protect data stored at a half word line and protect both the upper and lower bytes of the logical pages 230, the memory system 110 may change the RAIN stripe ID mapping on the word line 410, such that the lower bytes and the upper bytes of the same logical page 230 may have different RAIN stripe IDs. By doing so, the memory system 110 may protect data stored at the lower bytes (e.g., 8 KB on the left half plane 205-a) and data stored at the upper bytes (e.g., 8 KB on the right half plane 205-b) of the same logical page 230 using different RAIN stripes. That is, the memory system 110 (or host system 105) may change an order of the RAIN stripe ID (e.g., from being sequential to non-sequential), such that the lower bytes and the upper bytes of each RAIN stripe may be associated with different logical pages 230.

As an illustrative example, the lower bytes of the lower logical page 230 (e.g., LP-L) of the left half plane 205 (L) of the page 175-a may correspond to a RAIN stripe ID of ‘0’, while the upper bytes of the lower logical page 230 (e.g., LP-U) of the right half plane 205 (R) of the page 175-a may correspond to a RAIN stripe ID of ‘23’. Similarly, the lower bytes of the upper logical page 230 (e.g., UP-L) of the left half plane 205 of the page 175-a may correspond to a RAIN stripe ID of ‘1’, while the upper bytes of the upper logical page 230 (e.g., UP-U) of the right half plane 205 of the page 175-a may correspond to a RAIN stripe ID of ‘22’. Additionally, the lower bytes of the extra logical page 230 (e.g., XP-L) of the left half plane 205 of the page 175-a may correspond to a RAIN stripe ID of ‘2’, while the upper bytes of the extra logical page 230 (e.g., XP-U) of the right half plane 205 of the page 175-a may correspond to a RAIN stripe ID of ‘21’. Such a mapping between the RAIN stripe IDs and logical pages 230 may alternate, in a non-sequential order, across each page 175 across the plane 165, as illustrated in FIG. 4A.

FIG. 4B shows an example of a data protection scheme 400 that supports enhanced data protection schemes for memory systems in accordance with examples as disclosed herein. Aspects of the data protection scheme 401 may be implemented by aspects of the system 100 and the memory architecture 200. For example, the data protection scheme may be implemented by a memory system 110 (via a memory system controller 115), a host system 105 (via the host system controller 106), or a combination of both. The data protection scheme 401 may illustrate reordering of a mapping between the RAIN stripe IDs and logical pages 230 using the techniques described herein with reference to FIG. 3A. That is, the techniques described in the context of the data protection scheme 401 may enable a memory system 110 to implement the techniques of FIG. 3A in the context of additional pages 175 and various permutations of the RAIN stripe ID ordering within the pages 175.

In some examples, each plane 165 may include a page 175-a, a page 175-b, a page 175-c, a page 175-d, a page 175-e, a page 175-f, a page 175-g, and a page 175-h. Each page 175 may include three logical pages 230, such as the lower logical page 230, the upper logical page 230, and the extra logical page 230. Each of the logical pages 230 may include respective lower bytes corresponding to a left half plane 205-a (L) and respective upper bytes corresponding to a right half plane 205-a (R). Additionally, as described herein with reference to FIG. 2, the plane 165 may include multiple word lines at each respective level of the pillars 220, such as the word line 405, the word line 410, and the word line 415, where each word line may be separated into a left half word line and a right half word line.

In accordance with the techniques described herein, to protect data stored at a half word line and protect both the upper and lower bytes of the logical pages 230, the memory system 110 may change the RAIN stripe ID mapping on the word line, such that the lower bytes and the upper bytes of the same logical page 230 may have different RAIN stripe IDs. By doing so, the memory system 110 may protect data stored at the lower bytes (e.g., 8 KB on the left half plane 205-a) and data stored at the upper bytes (e.g., 8 KB on the right half plane 205-b) of the same logical page 230 using different RAIN stripes. That is, the memory system 110 (or host system 105) may change an order of the RAIN stripe ID (e.g., from being sequential to non-sequential), such that the lower bytes and the upper bytes of each RAIN stripe may be associated with different logical pages 230.

In the example of the data protection scheme 400, the memory system 110 may reorder the mapping between the logical pages 230 and the RAIN stripe IDs according to a first order for a first subset of the pages 175 (e.g., for the pages 175-a through 175-d) and reorder the mapping between the logical pages 230 and the RAIN stripe IDs according to a second order for a second subset of the pages 175 (e.g., for the pages 175-e through 175-h).

As an illustrative example of the first order, the lower bytes of the lower logical page 230 (e.g., LP-L) of the left half plane 205 (L) of the page 175-a may correspond to a RAIN stripe ID of ‘0’, while the upper bytes of the lower logical page 230 (e.g., LP-U) of the right half plane 205 (R) of the page 175-a may correspond to a RAIN stripe ID of ‘1’. Similarly, the lower bytes of the upper logical page 230 (e.g., UP-L) of the left half plane 205 of the page 175-a may correspond to a RAIN stripe ID of ‘2’, while the upper bytes of the upper logical page 230 (e.g., UP-U) of the right half plane 205 of the page 175-a may correspond to a RAIN stripe ID of ‘3’. Additionally, the lower bytes of the extra logical page 230 (e.g., XP-L) of the left half plane 205 of the page 175-a may correspond to a RAIN stripe ID of ‘4’, while the upper bytes of the extra logical page 230 (e.g., XP-U) of the right half plane 205 of the page 175-a may correspond to a RAIN stripe ID of ‘5’. Such a mapping between the RAIN stripe IDs and logical pages 230 may alternate, in a sequential order, across the first subset of pages 175, as illustrated in FIG. 4B.

As an illustrative example of the second order, the lower bytes of the lower logical page 230 (e.g., LP-L) of the left half plane 205 (L) of the page 175-e and the page 175—may correspond to a RAIN stripe ID of ‘1’, while the upper bytes of the lower logical page 230 (e.g., LP-U) of the right half plane 205 (R) of the page 175-e may correspond to a RAIN stripe ID of ‘0’. Similarly, the lower bytes of the upper logical page 230 (e.g., UP-L) of the left half plane 205 of the page 175-e may correspond to a RAIN stripe ID of ‘3’, while the upper bytes of the upper logical page 230 (e.g., UP-U) of the right half plane 205 of the page 175-a may correspond to a RAIN stripe ID of ‘2’. Additionally, the lower bytes of the extra logical page 230 (e.g., XP-L) of the left half plane 205 of the page 175-e may correspond to a RAIN stripe ID of ‘5’, while the upper bytes of the extra logical page 230 (e.g., XP-U) of the right half plane 205 of the page 175-c may correspond to a RAIN stripe ID of ‘4’. Such a mapping between the RAIN stripe IDs and logical pages 230 may alternate, in a non-sequential order, across the second subset of pages 175, as illustrated in FIG. 4B.

As described herein, the memory system 110 may reorder the RAIN stripe ID to logical page 230 mapping using one or more various permutations. Although not all listed here, it should be understood that the described techniques may be implemented using any permutation of such a mapping that results in the upper and lower bytes of a same logical page 230 mapping to different RAIN stripe IDs.

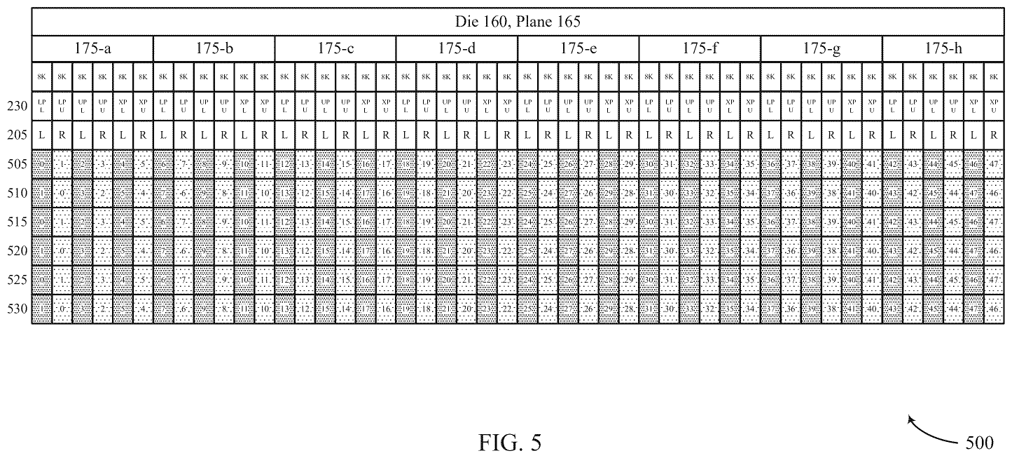

FIG. 5 shows an example of a data protection scheme 500 that supports enhanced data protection schemes for memory systems in accordance with examples as disclosed herein. Aspects of the data protection scheme 500 may be implemented by aspects of the system 100 and the memory architecture 200. For example, the data protection scheme 500 may be implemented by a memory system 110 (via a memory system controller 115), a host system 105 (via the host system controller 106), or a combination of both. The data protection scheme 500 may illustrate reordering of a mapping between the RAIN stripe IDs and logical pages 230 across multiple word liens using the techniques described herein with reference to FIG. 3A.

In some examples, each plane 165 may include a page 175-a, a page 175-b, a page 175-c, a page 175-d, a page 175-e, a page 175-f, a page 175-g, and a page 175-h. Each page 175 may include three logical pages 230, such as the lower logical page 230, the upper logical page 230, and the extra logical page 230. Each of the logical pages 230 may include respective lower bytes corresponding to a left half plane 205-a (L) and respective upper bytes corresponding to a right half plane 205-a (R). Additionally, as described herein with reference to FIG. 2, the plane 165 may include multiple word lines at each respective level of the pillars 220, such as the word line 505, the word line 510, the word line 515, the word line 525, and the word line 530, where each word line may be separated into a left half word line and a right half word line.

In some examples, the memory system 110 may determine to protect two consecutive half word lines (e.g., protect against word line to word line shorts), such as the word line 515 and 520 by generating parity bit sets according to the techniques described herein with reference to FIGS. 2 and 3A. For example, to protect data stored at a half word line for the word line 515 and the word line 520 and protect both the upper and lower bytes of the logical pages 230, the memory system 110 may change the RAIN stripe ID mapping on each of the word lines, such that the lower bytes and the upper bytes of the same logical page 230 may have different RAIN stripe IDs. By doing so, the memory system 110 may protect data stored at the lower bytes (e.g., 8 KB on the left half plane 205-a) and data stored at the upper bytes (e.g., 8 KB on the right half plane 205-b) of the same logical page 230 using different RAIN stripes. That is, the memory system 110 (or host system 105) may change an order of the RAIN stripe ID (e.g., from being sequential to non-sequential), such that the lower bytes and the upper bytes of each RAIN stripe may be associated with different logical pages 230.

Accordingly, as illustrated, the memory system 110 may determine to reorder the RAIN stripe IDs to logical page 230 mappings according to a first order (e.g., a sequential order) for the word lines 505, 515, and 525 and reorder the RAIN stripe IDs to logical page 230 mappings according to a second order (e.g., a non-sequential order) for the word lines 510, 520, and 530. In this way, due to the same logical page 230 of the same page 175 having a different RAIN stripe ID, the memory system may protect two consecutive half word lines for a subset of the pages 175 by generating multiple parity bits sets, where a first subset of the parity bit sets corresponds to a left half plane 205-a of a first word line and a second subset of the parity bit sets corresponds to a right half plane 205-b of a second word line, a third subset of the parity bit sets corresponds to a left half plane 205-a of a second word line, and a fourth subset of the parity bit sets corresponds to a right half plane 205-a of the second word line.

As an illustrative example, the memory system 110 may generate a first set of parity bit sets associated with the word line 515, where each parity bit set of the first set corresponds to one of the RAIN stripe IDs 0, 2, 4, 6, 8, 10, 12, 14, 16, 18, 20, and 22, thereby protecting the left half of the word line 515 for the pages 175-a through 175-d (e.g., a quarter of the word line 515). The memory system 110 may generate a second set of parity bit sets associated with the word line 515, where each parity bit set of the second set corresponds to one of the RAIN stripe IDs 1, 3, 5, 7, 9, 11, 13, 15, 17, 19, 21, and 23, thereby protecting the right half of the word line 515 for the pages 175-a through 175-d (e.g., a quarter of the word line 515). In such examples, a combination of the first set of parity bit sets and the second set of parity bit sets may protect a half of the word line 515.

Similarly, the memory system 110 may generate a third set of parity bit sets associated with the word line 520, where each parity bit set of the third set corresponds to one of the RAIN stripe IDs 0, 2, 4, 6, 8, 10, 12, 14, 16, 18, 20, and 22, thereby protecting the right half of the word line 520 for the pages 175-a through 175-d (e.g., a quarter of the word line 520). The memory system 110 may generate a fourth set of parity bit sets associated with the word line 520, where each parity bit set of the second set corresponds to one of the RAIN stripe IDs 1, 3, 5, 7, 9, 11, 13, 15, 17, 19, 21, and 23, thereby protecting the left half of the word line 520 for the pages 175-a through 175-d (e.g., a quarter of the word line 515). In such examples, a combination of the third set of parity bit sets and the fourth set of parity bit sets may protect a half of the word line 520. As such, the memory system 110 may store the sets of parity bit sets in the local memory 120, such that if short occurs between the word line 515 and the word line 520, the memory system 110 may utilize the sets of parity bit sets to recover the data.

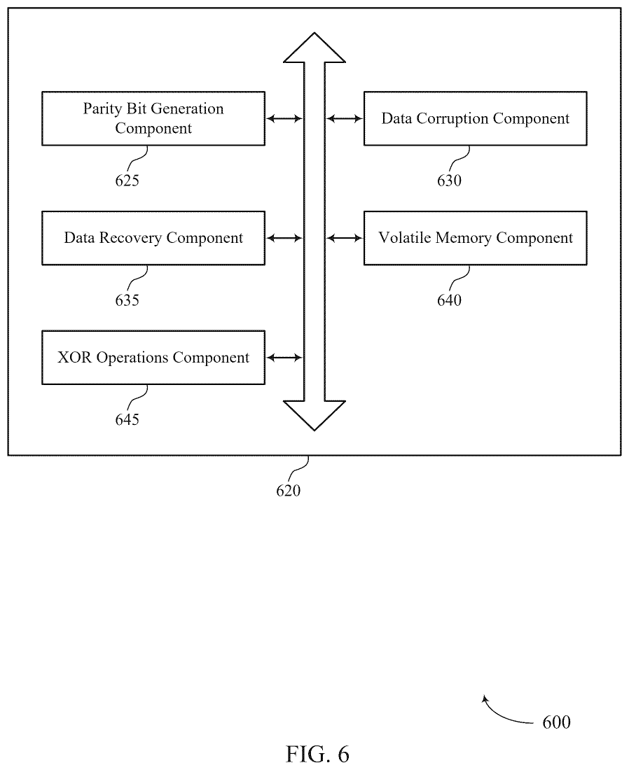

FIG. 6 shows a block diagram 600 of a memory system 620 that supports enhanced data protection schemes for memory systems in accordance with examples as disclosed herein. The memory system 620 may be an example of aspects of a memory system as described with reference to FIGS. 1 through 5. The memory system 620, or various components thereof, may be an example of means for performing various aspects of enhanced data protection schemes for memory systems as described herein. For example, the memory system 620 may include a parity bit generation component 625, a data corruption component 630, a data recovery component 635, a volatile memory component 640, a XOR operations component 645, or any combination thereof. Each of these components, or components of subcomponents thereof (e.g., one or more processors, one or more memories), may communicate, directly or indirectly, with one another (e.g., via one or more buses).

The parity bit generation component 625 may be configured as or otherwise support a means for generating a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages. The data corruption component 630 may be configured as or otherwise support a means for detecting a corruption of data at a first logical page of the plurality of logical pages. The data recovery component 635 may be configured as or otherwise support a means for recovering, as part of the data recovery procedure and based at least in part on detecting the corruption, the data using a first parity bit set of the plurality of parity bit sets, the first parity bit set corresponding to the first logical page.

In some examples, the volatile memory component 640 may be configured as or otherwise support a means for storing, in volatile memory of the memory system, the plurality of parity bit sets, where an order of the plurality of parity bit sets in the volatile memory alternates between the first subset of the plurality of parity bit sets and the second subset of the plurality of parity bit sets, and where the order is based at least in part on a respective identifier associated with each parity bit set of the plurality of parity bit sets.

In some examples, the order of the first subset of the plurality of parity bit sets and the second subset of the plurality of parity bit sets is sequential according to the respective identifiers associated with each parity bit set of the plurality of parity bit sets.

In some examples, the order of the first subset of the plurality of parity bit sets and the second subset of the plurality of parity bit sets is non-sequential according to the respective identifiers associated with each parity bit set of the plurality of parity bit sets.

In some examples, the XOR operations component 645 may be configured as or otherwise support a means for performing an XOR operation on respective data stored at a subset of a respective first logical page across a plurality of planes to generate the first parity bit set, where recovering the data using the first parity bit set is based at least in part on performing the XOR operation on the respective data.

In some examples, the first subset of the plurality of parity bit sets correspond to a first half of a plurality of planes of memory cells. In some examples, the second subset of the plurality of parity bit sets correspond to a second half of the plurality of planes of memory cells.

In some examples, the first subset of the plurality of parity bit sets correspond to a first half of a word line. In some examples, the second subset of the plurality of parity bit sets corresponds to a second half of the word line, a combination of the first half of the word line and the second half of the word line corresponding to a first subset of a plurality of subblocks.

In some examples, the first subset of the plurality of parity bit sets correspond to a second half of a word line. In some examples, the second subset of the plurality of parity bit sets corresponds to a first half of the word line, a combination of the first half of the word line and the second half of the word line corresponding to a first subset of a plurality of subblocks.

In some examples, the first subset of the plurality of parity bit sets correspond to a first half of a word line that is associated with a first subset of a plurality of subblocks of memory cells, the second subset of the plurality of parity bit sets correspond to a second half of the word line that is associated with the first subset of the plurality of subblocks of memory cells, a third subset of the plurality of parity bit sets correspond to a second half of a second word line that is associated with the first subset of the plurality of subblocks of memory cells, and a fourth subset of the plurality of parity bit sets corresponds to a first half of the second word line that is associated with the first subset of the plurality of subblocks of memory cells.

In some examples, the plurality of parity bit sets are generated by the memory system.

In some examples, the plurality of parity bit sets are generated by generated by a host system.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

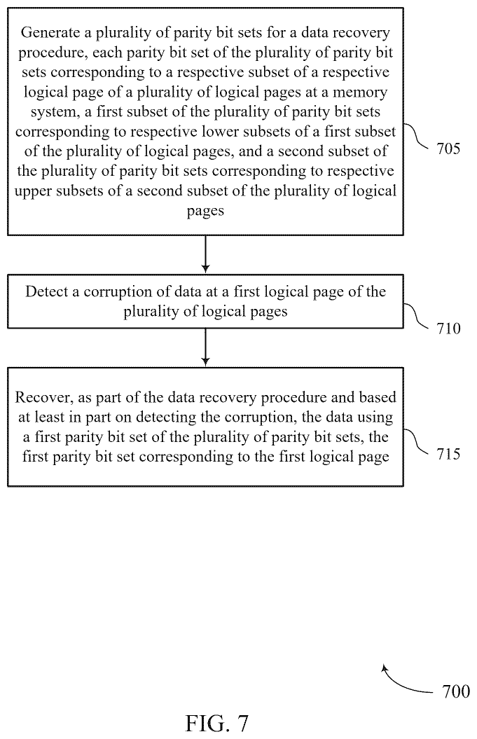

FIG. 7 shows a flowchart illustrating a process 700 that supports enhanced data protection schemes for memory systems in accordance with examples as disclosed herein. The operations of process 700 may be implemented by a memory system or its components as described herein. For example, the operations of process 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the process may include generating a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages. In some examples, aspects of the operations of 705 may be performed by a parity bit generation component 625 as described with reference to FIG. 6.

At 710, the process may include detecting a corruption of data at a first logical page of the plurality of logical pages. In some examples, aspects of the operations of 710 may be performed by a data corruption component 630 as described with reference to FIG. 6.

At 715, the process may include recovering, as part of the data recovery procedure and based at least in part on detecting the corruption, the data using a first parity bit set of the plurality of parity bit sets, the first parity bit set corresponding to the first logical page. In some examples, aspects of the operations of 715 may be performed by a data recovery component 635 as described with reference to FIG. 6.

In some examples, an apparatus as described herein may perform a process or processes, such as the process 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for generating a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages; detecting a corruption of data at a first logical page of the plurality of logical pages; and recovering, as part of the data recovery procedure and based at least in part on detecting the corruption, the data using a first parity bit set of the plurality of parity bit sets, the first parity bit set corresponding to the first logical page.

Aspect 2: The method, apparatus, or non-transitory computer-readable medium of aspect 1, further including operations, features, circuitry, logic, means, or instructions, or any combination thereof for storing, in volatile memory of the memory system, the plurality of parity bit sets, where an order of the plurality of parity bit sets in the volatile memory alternates between the first subset of the plurality of parity bit sets and the second subset of the plurality of parity bit sets, and where the order is based at least in part on a respective identifier associated with each parity bit set of the plurality of parity bit sets.

Aspect 3: The method, apparatus, or non-transitory computer-readable medium of aspect 2, where the order of the first subset of the plurality of parity bit sets and the second subset of the plurality of parity bit sets is sequential according to the respective identifiers associated with each parity bit set of the plurality of parity bit sets.

Aspect 4: The method, apparatus, or non-transitory computer-readable medium of any of aspects 2 through 3, where the order of the first subset of the plurality of parity bit sets and the second subset of the plurality of parity bit sets is non-sequential according to the respective identifiers associated with each parity bit set of the plurality of parity bit sets.

Aspect 5: The method, apparatus, or non-transitory computer-readable medium of any of aspects 1 through 4, further including operations, features, circuitry, logic, means, or instructions, or any combination thereof for performing an XOR operation on respective data stored at a subset of a respective first logical page across a plurality of planes to generate the first parity bit set, where recovering the data using the first parity bit set is based at least in part on performing the XOR operation on the respective data.

Aspect 6: The method, apparatus, or non-transitory computer-readable medium of any of aspects 1 through 5, where the first subset of the plurality of parity bit sets correspond to a first half of a plurality of planes of memory cells and the second subset of the plurality of parity bit sets correspond to a second half of the plurality of planes of memory cells.

Aspect 7: The method, apparatus, or non-transitory computer-readable medium of any of aspects 1 through 6, where the first subset of the plurality of parity bit sets correspond to a first half of a word line and the second subset of the plurality of parity bit sets corresponds to a second half of the word line, a combination of the first half of the word line and the second half of the word line corresponding to a first subset of a plurality of subblocks.

Aspect 8: The method, apparatus, or non-transitory computer-readable medium of any of aspects 1 through 7, where the first subset of the plurality of parity bit sets correspond to a second half of a word line and the second subset of the plurality of parity bit sets corresponds to a first half of the word line, a combination of the first half of the word line and the second half of the word line corresponding to a first subset of a plurality of subblocks.

Aspect 9: The method, apparatus, or non-transitory computer-readable medium of any of aspects 1 through 8, where the first subset of the plurality of parity bit sets correspond to a first half of a word line that is associated with a first subset of a plurality of subblocks of memory cells, the second subset of the plurality of parity bit sets correspond to a second half of the word line that is associated with the first subset of the plurality of subblocks of memory cells, a third subset of the plurality of parity bit sets correspond to a second half of a second word line that is associated with the first subset of the plurality of subblocks of memory cells, and a fourth subset of the plurality of parity bit sets corresponds to a first half of the second word line that is associated with the first subset of the plurality of subblocks of memory cells.

Aspect 10: The method, apparatus, or non-transitory computer-readable medium of any of aspects 1 through 9, where the plurality of parity bit sets are generated by the memory system.

Aspect 11: The method, apparatus, or non-transitory computer-readable medium of any of aspects 1 through 10, where the plurality of parity bit sets are generated by generated by a host system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
generate a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages;
detect a corruption of data at a first logical page of the plurality of logical pages; and
recover, as part of the data recovery procedure and in response to detecting the corruption, the data using a first parity bit set of the plurality of parity bit sets, the first parity bit set corresponding to the first logical page.

2. The apparatus of claim 1, wherein the processing circuitry is configured to cause the apparatus to:
store, in volatile memory of the memory system, the plurality of parity bit sets, wherein an order of the plurality of parity bit sets in the volatile memory alternates between the first subset of the plurality of parity bit sets and the second subset of the plurality of parity bit sets, and wherein the order is in accordance with a respective identifier associated with each parity bit set of the plurality of parity bit sets.

3. The apparatus of claim 2, wherein the order of the first subset of the plurality of parity bit sets and the second subset of the plurality of parity bit sets is sequential according to the respective identifiers associated with each parity bit set of the plurality of parity bit sets.

4. The apparatus of claim 2, wherein the order of the first subset of the plurality of parity bit sets and the second subset of the plurality of parity bit sets is non-sequential according to the respective identifiers associated with each parity bit set of the plurality of parity bit sets.

5. The apparatus of claim 1, wherein the processing circuitry is configured to cause the apparatus to:
perform an XOR operation on respective data stored at a subset of a respective first logical page across a plurality of planes to generate the first parity bit set, wherein recovering the data using the first parity bit set is in response to performing the XOR operation on the respective data.

6. The apparatus of claim 1, wherein:
the first subset of the plurality of parity bit sets correspond to a first half of a plurality of planes of memory cells, and
the second subset of the plurality of parity bit sets correspond to a second half of the plurality of planes of memory cells.

7. The apparatus of claim 1, wherein:
the first subset of the plurality of parity bit sets correspond to a first half of a word line, and
the second subset of the plurality of parity bit sets corresponds to a second half of the word line, a combination of the first half of the word line and the second half of the word line corresponding to a first subset of a plurality of subblocks.

8. The apparatus of claim 1, wherein:
the first subset of the plurality of parity bit sets correspond to a second half of a word line, and
the second subset of the plurality of parity bit sets corresponds to a first half of the word line, a combination of the first half of the word line and the second half of the word line corresponding to a first subset of a plurality of subblocks.

9. The apparatus of claim 1, wherein:
the first subset of the plurality of parity bit sets correspond to a first half of a word line that is associated with a first subset of a plurality of subblocks of memory cells,
the second subset of the plurality of parity bit sets correspond to a second half of the word line that is associated with the first subset of the plurality of subblocks of memory cells,
a third subset of the plurality of parity bit sets correspond to a second half of a second word line that is associated with the first subset of the plurality of subblocks of memory cells, and
a fourth subset of the plurality of parity bit sets corresponds to a first half of the second word line that is associated with the first subset of the plurality of subblocks of memory cells.

10. The apparatus of claim 1, wherein the plurality of parity bit sets are generated by the memory system.

11. The apparatus of claim 1, wherein the plurality of parity bit sets are generated by generated by a host system.

12. A non-transitory computer-readable medium storing code comprising instructions which, when executed by one or more processors of an apparatus, to cause the apparatus to:
generate a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages;
detect a corruption of data at a first logical page of the plurality of logical pages; and
recover, as part of the data recovery procedure and in response to detecting the corruption, the data using a first parity bit set of the plurality of parity bit sets, the first parity bit set corresponding to the first logical page.

13. The non-transitory computer-readable medium of claim 12, wherein the instructions, when executed by the one or more processors of the apparatus, further cause the apparatus to:
store, in volatile memory of the memory system, the plurality of parity bit sets, wherein an order of the plurality of parity bit sets in the volatile memory alternates between the first subset of the plurality of parity bit sets and the second subset of the plurality of parity bit sets, and wherein the order is in accordance with a respective identifier associated with each parity bit set of the plurality of parity bit sets.

14. The non-transitory computer-readable medium of claim 13, wherein the order of the first subset of the plurality of parity bit sets and the second subset of the plurality of parity bit sets is sequential according to the respective identifiers associated with each parity bit set of the plurality of parity bit sets.

15. The non-transitory computer-readable medium of claim 13, wherein the order of the first subset of the plurality of parity bit sets and the second subset of the plurality of parity bit sets is non-sequential according to the respective identifiers associated with each parity bit set of the plurality of parity bit sets.

16. The non-transitory computer-readable medium of claim 12, wherein the instructions, when executed by the one or more processors of the apparatus, further cause the apparatus to:
perform an XOR operation on respective data stored at a subset of a respective first logical page across a plurality of planes to generate the first parity bit set, wherein recovering the data using the first parity bit set is in response to performing the XOR operation on the respective data.

17. The non-transitory computer-readable medium of claim 12, wherein:
the first subset of the plurality of parity bit sets correspond to a first half of a plurality of planes of memory cells, and
the second subset of the plurality of parity bit sets correspond to a second half of the plurality of planes of memory cells.

18. The non-transitory computer-readable medium of claim 12, wherein:
the first subset of the plurality of parity bit sets correspond to a first half of a word line, and
the second subset of the plurality of parity bit sets corresponds to a second half of the word line, a combination of the first half of the word line and the second half of the word line corresponding to a first subset of a plurality of subblocks.

19. The non-transitory computer-readable medium of claim 12, wherein:
the first subset of the plurality of parity bit sets correspond to a second half of a word line, and
the second subset of the plurality of parity bit sets corresponds to a first half of the word line, a combination of the first half of the word line and the second half of the word line corresponding to a first subset of a plurality of subblocks.

20. The non-transitory computer-readable medium of claim 12, wherein:
the first subset of the plurality of parity bit sets correspond to a first half of a word line that is associated with a first subset of a plurality of subblocks of memory cells,
the second subset of the plurality of parity bit sets correspond to a second half of the word line that is associated with the first subset of the plurality of subblocks of memory cells,
a third subset of the plurality of parity bit sets correspond to a second half of a second word line that is associated with the first subset of the plurality of subblocks of memory cells, and
a fourth subset of the plurality of parity bit sets corresponds to a first half of the second word line that is associated with the first subset of the plurality of subblocks of memory cells.

21. The non-transitory computer-readable medium of claim 12, wherein the plurality of parity bit sets are generated by the memory system.

22. The non-transitory computer-readable medium of claim 12, wherein the plurality of parity bit sets are generated by generated by a host system.

23. A method, comprising:
generating a plurality of parity bit sets for a data recovery procedure, each parity bit set of the plurality of parity bit sets corresponding to a respective subset of a respective logical page of a plurality of logical pages at a memory system, a first subset of the plurality of parity bit sets corresponding to respective lower subsets of a first subset of the plurality of logical pages, and a second subset of the plurality of parity bit sets corresponding to respective upper subsets of a second subset of the plurality of logical pages;
detecting a corruption of data at a first logical page of the plurality of logical pages; and
recovering, as part of the data recovery procedure and in response to detecting the corruption, the data using a first parity bit set of the plurality of parity bit sets, the first parity bit set corresponding to the first logical page.
